(19) United States
(12) Patent Application Publication
(10) Pub. No.: US 2018/0056341 A1
(43) Pub. Date: Mar. 1, 2018

(54) COMPACT APPARATUS FOR REMOVING SCALE

(71) Applicant: SEUNG RYUL PARK, Namyangju-si (KR)

(72) Inventor: SEUNG RYUL PARK, Namyangju-si (KR)

(21) Appl. No.: 15/656,392

(22) Filed: Jul. 21, 2017

(30) Foreign Application Priority Data
Aug. 31, 2016 (KR) 10-2016-0111562

(51) Int. Cl. B08B 9/043

(52) U.S. Cl. CPC B08B 9/0436

(57) ABSTRACT

A compact apparatus for removing scale includes: a wire spring mounted at an end thereof with a cutting blade and having a predetermined force to remove the scale from a pipe; a first gear unit; a second gear unit rotatably coupled to the first gear unit; a vertical gear unit having a rotation axis perpendicular to the second gear unit, rotatably coupled to the second gear unit, and including a first guide wheel for moving the wire spring in one direction or an opposite direction; a connection gear unit rotatably coupled to the vertical gear unit, and including a second guide wheel disposed horizontally in a same plane with the first guide wheel to move the wire spring in one direction or the opposite direction together with the first guide wheel; and a support plate for rotatably supporting the vertical gear unit and the connection gear unit.

### BACKGROUND OF THE INVENTION

### 1. Field of the Invention

The present technique relates to a compact apparatus for removing scale.

More particularly, the present technique relates to a compact apparatus for removing scale, in which a wire spring operates while being guided between a first guide wheel and a second guide wheel, so that the wire spring is guided in a precise direction with a constant force, thereby efficiently removing the scale.

### 2. Description of the Related Art

Korean Patent Application Publication No. 10-2015-0019462 discloses an invention related to “Scale Removal Device in Large-pipe”.

In addition, “Wire Device for Removing Scale in Pipe” is disclosed in Korean Patent Application Publication No. 10-2015-0010480.

In general, a pipe for transferring various fluids such as water is usually embedded or installed in the floor or wall of a building, and when the pipe is used for a long period of time, scale is generated as the inner wall of the pipe is oxidized and corroded or various foreign substances sticks onto the inner wall.

Particularly, since a flow path of the pipe becomes narrow as the scale is solidified over a long period of time, the water pressure or the like may be decreased, or in the severe case, the pipe may be broken without withstanding the transfer pressure.

Generally, a typical way to remove the scale is to insert a blade into the pipe to crush and remove the scale.

If the pipe is small, it requires a compact apparatus for removing the scale, in which a cutting blade or the like for removing the scale is mounted at an end of a wire spring.

When the scale is removed, such a compact apparatus for removing the scale has a problem that the wire spring is released by receiving the repulsive force as the wire spring collides with the scale of the pipe.

In addition, since the wire spring has to be precisely moved inside the pipe that has a small diameter to remove the scale, the wire spring has to be precisely controlled according to the intent of a person who desires to remove the scale.

Further, the compact apparatus for removing the scale is generally fixed to a frame or the like which makes contact with the pipe, so that the compact apparatus for removing the scale may be rotated by the force of a power source.

Therefore, in the case of a compact apparatus for removing scale of a small pipe, it is necessary to provide a compact apparatus for removing scale, in which the wire spring can be moved in the forward or backward direction with a constant force or a predetermined force, so that the wire spring is not released even if it collides with the scale of the small pipe or the like, the wire spring can be precisely moved according to the intent of a user who uses the compact apparatus for removing the scale so as to effectively remove the scale, and the compact apparatus for removing the scale is not rotated by the force of the power source.

### DOCUMENT OF RELATED ART

### Patent Document

(Patent document 1) Korean Patent Application Publication No. 10-2015-0019462, titled “Scale Removal Device in Large-pipe”

(Patent document 2) Korean Patent Application Publication No. 10-2015-0010480, titled “Wire Device for Removing Scale in Pipe”

### SUMMARY OF THE INVENTION

An object of the present invention is to provide a compact apparatus for removing scale, in which a wire spring is guided through a gear structure and is moved in the forward or backward direction while maintaining a predetermined force, so that the predetermined force is maintained even if a cutting blade mounted at an end of the wire spring collides with the scale, thereby preventing the wire spring from being released.

An object of the present invention is to provide a compact apparatus for removing scale, in which the wire spring is guided through the gear structure and is moved in the forward or backward direction, so that the wire spring is precisely controlled according to the intent of a user.

An object of the present invention is to provide a compact apparatus for removing scale, in which a balance plate is mounted on a support plate, so that the compact apparatus for removing the scale is not rotated even if the force of the power source is applied.

An object of the present invention is to provide a compact apparatus for removing scale, in which a connection gear shaft of a connection gear unit is rotatably coupled to an elastic support plate, and the elastic support plate is coupled to a support plate through an elastic member so as to be provided with an elastic force, so that the compact apparatus for removing the scale is not rotated even if the force of the power source is applied.

The technical objects of the present invention are not limited to the above-described technical objects, and other technical objects which are not mentioned will become apparent to those skilled in the art from the following description.

According to the present invention, a compact apparatus for removing scale includes a wire spring, a first gear unit, a second gear unit, a vertical gear unit, a connection gear unit, and a support plate.

The wire spring is provided to remove the scale from a pipe.

The wire spring may be mounted at an end thereof with a cutting blade and the like.

The wire spring has a predetermined force.

The first gear unit includes a first gear shaft and a first gear.

The first gear is formed along an outer periphery of the first gear shaft.

The second gear unit is rotatably coupled to the first gear unit.

The second gear unit includes a second gear shaft, a second gear, and a worm.

The second gear is formed along an outer periphery of the second gear shaft.

The second gear may be meshed with the first gear.

The worm is formed along the longitudinal direction of the second gear shaft.

The vertical gear unit is coupled to the second gear unit so as to be rotatable about a rotation axis perpendicular to the second gear unit.

The vertical gear unit includes a first guide wheel.

The first guide wheel is formed with a first guide groove to move the wire spring in one direction or the other direction.

The connection gear unit is rotatably coupled to the vertical gear unit.

The connection gear unit includes a second guide wheel.

The second guide wheel has a second guide groove and is disposed horizontally in the same plane with the first guide wheel.

Therefore, the second guide wheel moves the wire spring in one direction or the other direction together with the first guide wheel.

The support plate rotatably supports the vertical gear unit and the connection gear unit.

The first gear unit is formed with a through-hole along the longitudinal direction.

The through-hole allows the wire spring to move through the first gear unit.

The through-hole is disposed between the first guide groove formed on an outer periphery of the first guide wheel and the second guide groove formed on an outer periphery of the second guide wheel.

The support plate includes a first plate and a second plate.

The second plate is spaced apart from the first plate.

In addition, the first guide wheel and the second guide wheel are disposed in a space between the first plate and the second plate.

A connection plate connects the first plate and the second plate spaced apart from each other.

In addition, the connection plate has a bearing hole for rotatably supporting the second gear shaft.

The vertical gear unit includes a vertical gear shaft, the worm gear, the first guide wheel, and an active gear.

The worm gear, the first guide wheel, and the active gear are installed on the vertical gear shaft while being spaced apart from each other by a predetermined interval.

In addition, the worm gear and the active gear are not disposed at least in the space between the first plate and the second plate.

The connection gear unit includes a connection gear shaft that passes through an elastic support plate while being rotatably supported by the elastic support plate.

The support plate has an elastic support plate mounting portion on which the elastic support plate is mounted.

In addition, the elastic support plate is installed in the elastic support plate mounting portion and coupled to the support plate through an elastic member.

Further, a balance plate may be provided at both ends of the support plate to maintain balance.

According to an embodiment of the present invention, the compact apparatus for removing the scale, which has the above-described configuration, can be manufactured in a compact size and can efficiently remove the scale.

The compact apparatus for removing the scale according to an embodiment of the present invention guides the wire spring through the first guide wheel and the second guide wheel such that the wire spring can move in the forward or backward direction while maintaining a predetermined force, thereby preventing the tension of a spring from being released.

The compact apparatus for removing the scale according to an embodiment of the present invention can move the wire spring in the predetermined direction at a predetermined force through the first guide wheel and the second guide wheel, thereby precisely controlling the wire spring.

The compact apparatus for removing the scale according to an embodiment of the present invention includes the elastic member provided between the elastic support plate and the support plate so as to provide an elastic force to the elastic support plate, so that the compact apparatus for removing the scale is prevented from being rotated by the force of the power source.

The compact apparatus for removing the scale according to an embodiment of the present invention includes a balance plate provided at the end of the support plate to maintain the balance, so that the compact apparatus for removing the scale is prevented from being rotated by the force of the power source.

The technical objects of the present invention are not limited to the above-described technical objects, and other technical objects which are not mentioned will become apparent to those skilled in the art from the following description.

### BRIEF DESCRIPTION OF THE DRAWINGS

FIG. 1 is a perspective view showing a compact apparatus for removing scale according to an embodiment of the present invention.

FIG. 2 is a side view showing a compact apparatus for removing scale according to an embodiment of the present invention.

FIG. 3 is an exploded view showing a compact apparatus for removing scale according to an embodiment of the present invention.

FIG. 4 is a view showing the relation among a first gear unit, a first guide wheel, and a second guide wheel according to an embodiment of the present invention.

FIG. 5A shows a first plate according to an embodiment of the present invention, and FIG. 5B is a view showing a first elastic support plate according to an embodiment of the present invention.

FIG. 6 is a view showing the relation between a connection plate and a second gear unit according to an embodiment of the present invention.

FIG. 7 is a view showing the relation between a second plate and a balance plate according to an embodiment of the present invention.

### DETAILED DESCRIPTION OF THE INVENTION

Hereinafter, an embodiment of the present invention will be described in detail with reference to illustrative drawings. However, this is not intended to limit the scope of the invention.

When reference numerals are given to the elements of the drawings, it should be noted that the same reference numerals are used to designate the same or similar elements even when they are shown in different drawings. In addition, detailed descriptions of well-known functions and structures incorporated herein may be omitted when they make the subject matter rather unclear.

In addition, dimensions and shapes of the elements shown in the drawings may be exaggerated for clarity and convenience of explanation. Further, terms are specifically defined in consideration of the configuration and operation of the present invention to explain the embodiments of the present invention, and do not limit the scope of the present invention.

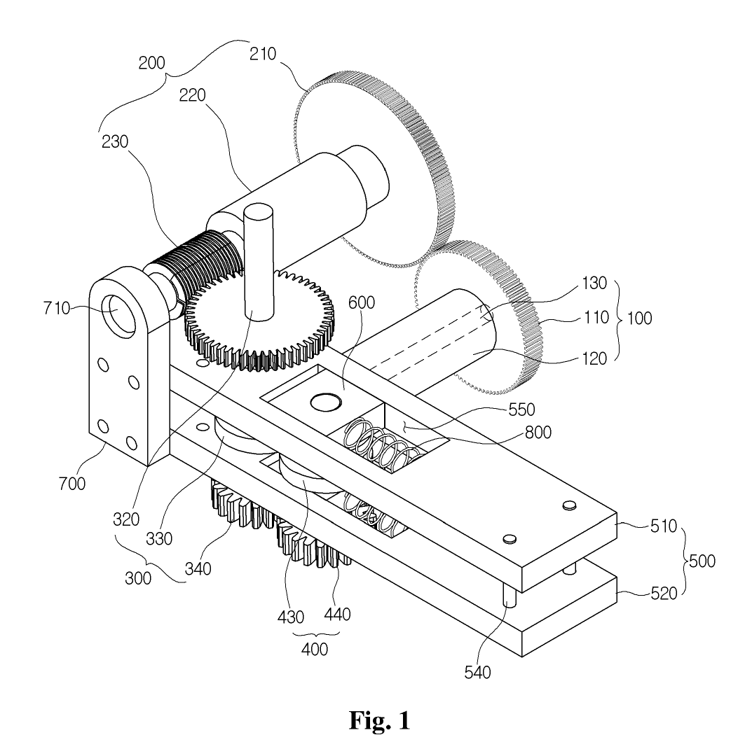

FIG. 1 is a perspective view showing a compact apparatus for removing scale according to an embodiment of the present invention.

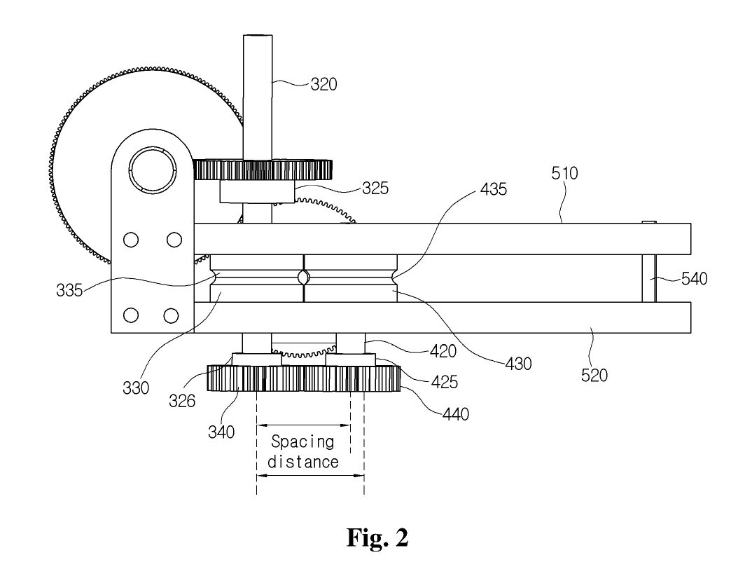

FIG. 2 is a side view showing a compact apparatus for removing scale according to an embodiment of the present invention.

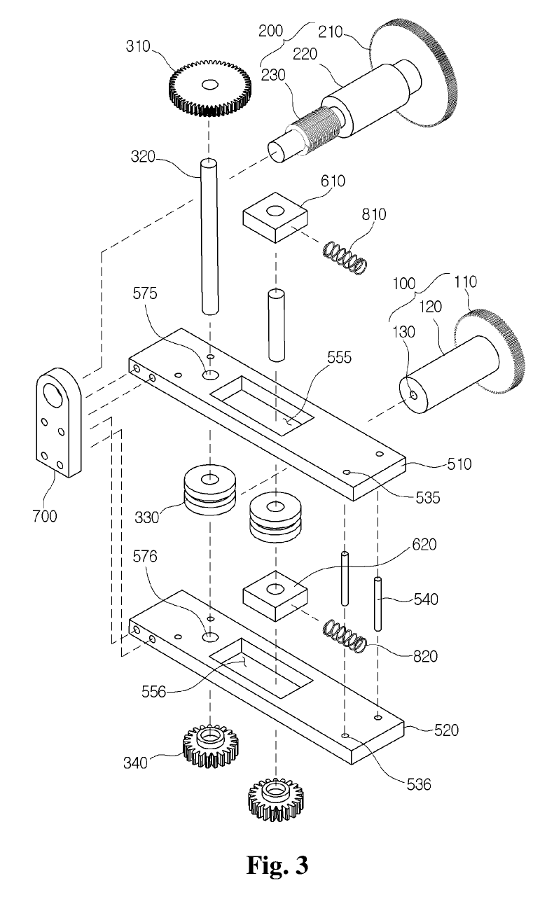

FIG. 3 is an exploded view showing a compact apparatus for removing scale according to an embodiment of the present invention.

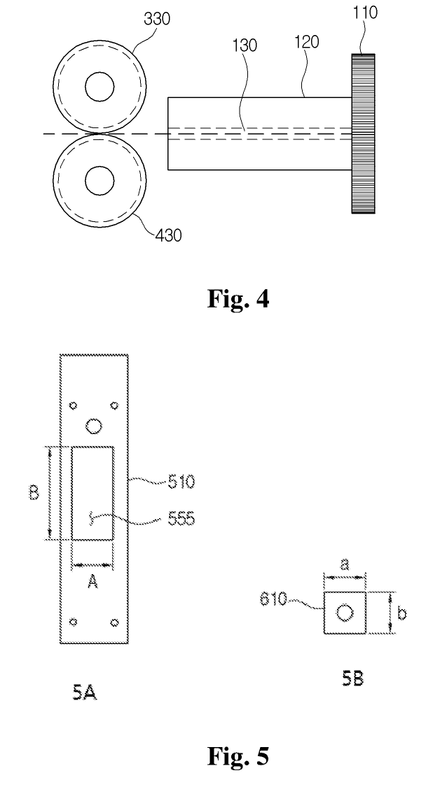

FIG. 4 is a view showing the relation among a first gear unit, a first guide wheel, and a second guide wheel according to an embodiment of the present invention.

FIG. 5A shows a first plate according to an embodiment of the present invention, and FIG. 5B is a view showing a first elastic support plate according to an embodiment of the present invention.

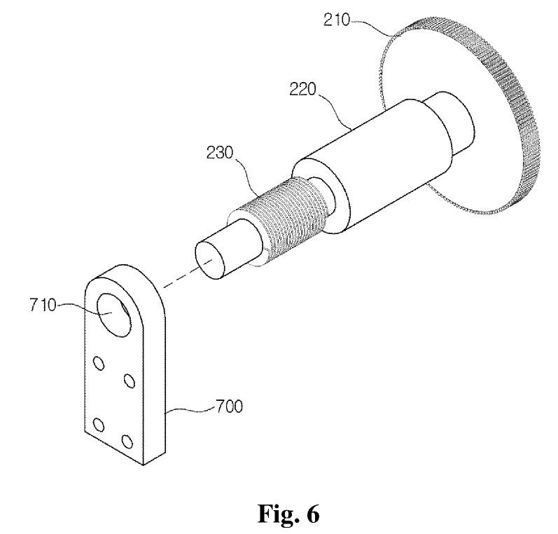

FIG. 6 is a view showing the relation between a connection plate and a second gear unit according to an embodiment of the present invention.

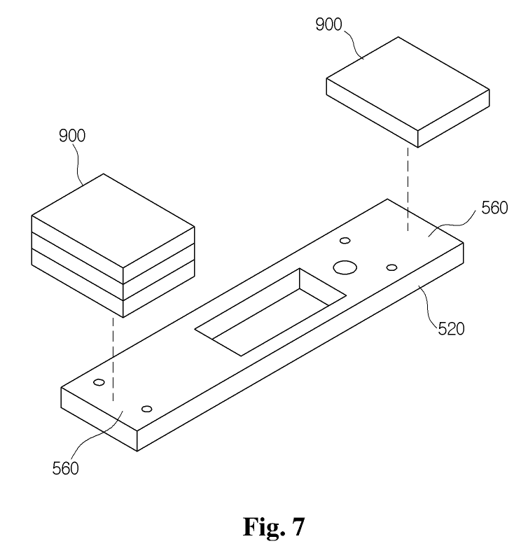

FIG. 7 is a view showing the relation between a second plate and a balance plate according to an embodiment of the present invention.

According to an embodiment of the present invention, a compact apparatus for removing scale includes a wire spring, a first gear unit 100, a second gear unit 200, a vertical gear unit 300, a connection gear unit 400, and a support plate 500.

The wire spring may be provided at an end thereof with a cutting blade (not shown).

The wire spring is stored in a wire spring storage unit.

The wire spring storage unit includes a chamber and a protruding shaft.

The wire spring may be stored inside the chamber in the form of a spiral, and one end of the wire spring can be observed on the protruding shaft.

According to one embodiment, the protruding shaft of the wire spring storage unit may transmit the power received from the first gear unit 100 and a power source.

Accordingly, one end of the wire spring may pass through a through-hole 130 of the first gear unit 100, and may be guided by a first guide wheel 330 and a second guide wheel 430 so as to be moved in one direction or the other direction.

The wire spring may have a predetermined force to remove the scale from a small pipe with the cutting blade (not shown).

In other words, the wire spring can be moved in the forward (one side) or backward (the other side) direction to remove the scale formed in the pipe with the cutting blade (not shown).

The wire spring includes a spring and a wire disposed inward of the spring.

Thus, the wire may prevent the spring of the wire spring from being twisted.

The power source transmits the power, which may rotate the first gear unit in one direction or the other direction, to the first gear unit.

In addition, according to one embodiment, the power source may include a motor. However, the power source may not be limited to the motor, but various devices can be adopted as the power source if they can rotate the first gear unit 100 in one direction or the other direction.

According to one embodiment, the power source may be coupled to the wire spring storage unit.

The first gear unit 100 includes a first gear shaft 120, a first gear 110, and a through-hole 130.

The first gear unit 100 rotates about a predetermined rotation axis.

The first gear unit 100 rotates about a first axis.

The first gear unit 100 can be rotated by receiving power from the power source.

The first gear shaft 120 has a predetermined length.

The first gear 110 is formed on an outer periphery of the other side of the first gear shaft 120.

The first gear 110 is meshed with a second gear 210 to transfer the rotation. In other words, when the first gear unit 100 is rotated, the second gear unit 200 is rotated about a second axis, which is a rotation axis parallel to the first axis.

The first gear 110 may be provided on an end side of the first gear shaft 120 according to an embodiment.

The through-hole 130 is formed in the first gear unit 100. The through-hole 130 is formed through the first gear unit 100 corresponding to a predetermined length of the first gear unit 100. The through-hole 130 may be provided therein with the wire spring. Therefore, the wire spring may pass through the through-hole 130 and may be guided by the first guide groove 335 and the second guide groove 435 formed on the first guide wheel 330 and the second guide wheel 430, respectively, so as to be moved in the forward or backward direction.

The through-hole 130 may be disposed between the first guide groove 335 of the first guide wheel 330 and the second guide groove 435 of the second guide wheel 430.

In other words, referring to FIG. 4, the through-hole 130, the first guide wheel 330, and the second guide wheel 430 may be arranged in a shape of “T” when observed from the top.

Therefore, the wire spring may pass through the first gear unit 100 while being guided in the precise direction by the first guide wheel 330 and the second guide wheel 430.

The second gear unit 200 may include a second gear 210, a second gear shaft 220, and a worm 230.

The second gear unit 200 is rotatably coupled to the first gear unit 100.

In other words, the second gear 210 is meshed and rotatably coupled with the first gear 110 of the first gear unit 100, so that the second gear unit 200 can be rotated in the same axial direction as the first gear unit 100.

Similar to the first gear shaft 120, the second gear shaft 220 of the second gear unit 200 may have a predetermined length.

Referring to FIG. 2, it is observed that the diameter of the second gear shaft 220 of the second gear unit 200 is changed.

The second gear 210 may be provided on the other side of the second gear shaft 220 along an outer periphery of the second gear shaft 220.

In addition, the diameter of the second gear 210 may be larger than the diameter of the second gear shaft 220.

The worm 230 may be formed on one side of the second gear shaft 220 along the longitudinal direction of the second gear shaft 220.

The worm 230 may be meshed with the worm gear 310. Thus, the second gear unit 200 may rotate the vertical gear unit 300 having the worm gear 310 in the vertical axial direction.

The vertical axis of the vertical gear unit 300 is a first rotation axis perpendicular to the first axis and the second axis.

Referring to the second gear shaft 220 and a bearing hole 710 shown in FIG. 6, the other end of the second gear shaft 220 may be coupled to the bearing hole 710 of a connection plate 700.

The bearing hole 710 rotatably supports the second gear shaft 220. Therefore, the second gear shaft 220 can be rotated while being supported by the bearing hole 710 at the other end.

The vertical gear unit 300 includes a vertical transfer gear, a vertical gear shaft 320, a first guide wheel 330, and an active gear 340.

In addition, according to one embodiment, the vertical transfer gear may include a worm gear 310.

In other words, the vertical transfer gear may not be limited to a specific type of gear, but various gears can be adopted as the vertical transfer gear if they mesh with the worm 230 of the second gear unit 200 and transfer the rotation with a rotation axis perpendicular to the rotation axis of the second gear unit 200.

The vertical gear unit 300 is coupled to the second gear unit 200 so as to be rotatable about a rotation axis perpendicular to the second gear unit 200.

The vertical gear shaft 320 of the vertical gear unit 300 has a predetermined length.

In addition, the vertical gear shaft 320 at least has a length suitable to pass through a space between the first plate 510 and the second plate 520, which are spaced apart from each other.

A worm gear support 325 is formed at an upper portion of the vertical gear shaft 320.

The worm gear support 325 rotatably supports the worm gear 310 such that the worm gear 310 can be meshed with the worm 230.

An active gear support 326 is formed at a lower portion the vertical gear shaft 320.

Thus, similar to the worm gear support 325, the active gear support 326 rotatably supports the active gear 340 such that the active gear 340 can be meshed with a passive gear 440.

Referring to the vertical gear unit 300 shown in FIG. 2, the worm gear 310, the first guide wheel 330, and the active gear 340 are installed on the vertical gear shaft 320 while being spaced apart from each other by a distance.

The worm gear 310 is meshed with the worm 230 of the second gear unit 200. Thus, the vertical gear can be rotated about an axis perpendicular to the second gear unit 200.

The worm gear 310 has a larger diameter than the active gear 340 and the first guide wheel 330.

The worm gear 310 is disposed over an upper surface of the first plate 510.

In other words, the worm 230 of the second gear unit 200 and the worm gear 310 of the vertical gear unit 300 are meshed with each other at a position over the upper surface of the first plate 510.

The diameter of the worm gear 310 is at least not less than the diameter of the vertical gear shaft 320.

The first guide wheel 330 is coupled to the vertical gear shaft 320 so as to rotate coaxially with the vertical gear shaft 320.

The first guide groove 335 is formed in the first guide wheel 330.

The first guide groove 335 may be formed along a central portion of the outer periphery of the first guide wheel 330.

The first guide groove 335 may be formed in a shape of a notch.

The first guide groove can be rotated together with the second guide groove 435 to guide the movement of the wire spring.

In other words, the first guide wheel 330 may move the wire spring together with the second guide wheel 430 with a predetermined force in one direction or the other direction according to the rotation of the first guide wheel 330.

According to one embodiment of the present invention, the first guide wheel 330 allows the wire spring to be precisely controlled, so that the wire spring may be guided and moved in one direction or the other direction.

The first guide wheel 330 may be installed in a space between the first plate 510 and the second plate 520 spaced apart from each other.

In other words, when a portion where the vertical gear unit 300 is installed is observed from top to bottom based on FIG. 2, there are elements disposed in the order of the worm gear 310, the first plate 510, the first guide wheel 330, the second plate 520, and the active gear 340.

The active gear 340 may be formed below the vertical gear shaft 320.

The active gear 340 is rotatably supported by the active gear support 326 of the vertical gear shaft 320.

The active gear 340 is meshed with the passive gear 440. Therefore, the passive gear 440 is meshed with the active gear 340 and can be rotated with the active gear 340.

The connection gear unit 400 is rotatably coupled to the vertical gear unit 300.

In addition, the fact that the connection gear unit 400 is rotatable with the vertical gear unit 300 indicates that the connection gear unit 400 rotates about a second rotation axis, which is parallel to the first rotation axis about which the vertical gear unit 300 rotates.

Accordingly, when the vertical gear unit 300 rotates about the first rotation axis, the connection gear unit 400 rotates about the second rotation axis according to the rotation of the vertical gear unit 300.

In other words, the passive gear 440 of the connection gear unit 400 is meshed with the active gear 340 so as to be rotatably coupled to the vertical gear unit 300.

The connection gear unit 400 includes a connection gear shaft 420, a second guide wheel 430, and a passive gear 440.

The connection gear shaft 420 has a predetermined length.

The predetermined length of the connection gear shaft 420 is at least not less than a distance between the first plate 510 and the second plate 520 spaced apart from each other.

A passive gear support 425 is formed below the connection gear shaft 420.

The passive gear support 425 rotatably supports the passive gear 440.

The second guide wheel 430 is coupled to the connection gear shaft 420.

The second guide wheel 430 is formed at a position corresponding to the first guide wheel 330.

In other words, the second guide wheel 430 is disposed horizontally in the same plane with the first guide wheel 330.

In other words, referring to the second guide wheel 430 based on FIG. 2, a virtual line extending from a central portion of the second guide wheel 430 to a central portion of the first guide wheel 330 is observed as a straight line.

Accordingly, similar to the first guide wheel 330, the second guide wheel 430 may be disposed in the space between the first plate 510 and the second plate 520 spaced apart from each other. The second guide groove 435 is formed at the central portion of the second guide wheel 430.

Similar to the first guide groove 335, the second guide groove 435 may be formed along the outer periphery of the second guide wheel 430.

The second guide groove 435 may have a shape similar to the notch.

The second guide wheel 430 can move the wire spring together with the first guide wheel 330 to one side or the other side between the first guide groove 335 and the second guide groove 435.

Therefore, the through-hole 130 of the first gear unit 100 has to be disposed between the first guide groove 335 and the second guide groove 435.

The passive gear 440 meshes with the active gear 340. Therefore, the passive gear 440 is meshed with the active gear 340 so as to rotate with the active gear 340.

The connection gear unit 400 is coupled to an elastic support plate 600.

In other words, the connection gear unit 400 is coupled to the support plate 500 through the elastic support plate 600.

Accordingly, the connection gear unit 400 is coupled to the elastic support plate 600, so that a spacing distance between the connection gear unit 400 and the vertical gear unit 300 can be elastically adjusted.

In other words, the spacing distance between the vertical gear unit 300 and the connection gear unit 400 may be elastically varied by an elastic member 800 coupled between the elastic support plate 600 and the support plate 500.

The support plate 500 rotatably supports the vertical gear unit 300 and the connection gear unit 400.

In other words, the support plate 500 includes a hole through which the vertical gear shaft 320 passes, and an elastic support plate mounting portion 550.

Therefore, the vertical gear shaft 320 is stably and rotatably installed through the hole of the support plate 500, and the elastic support plate 600 is mounted in the elastic support plate mounting portion 550, so that the connection gear unit 400 is also stably and rotatably installed by the elastic support plate 600.

The support plate 500 includes a first plate 510 and a second plate 520.

The first plate 510 and the second plate 520 are spaced apart from each other.

In other words, the first plate 510 is disposed on an upper side, and the second plate 520 is disposed on a lower side while being spaced apart from the first plate 510.

The first plate 510 and the second plate 520 have a sectional shape similar to each other.

In addition, the first plate 510 and the second plate 520 may have a rectangular sectional shape.

The first guide wheel 330 and the second guide wheel 430 are disposed in the space between the first plate 510 and the second plate 520 spaced apart from each other.

In addition, the first plate 510 and the second plate 520 are formed at corresponding positions thereof with the hole through which the vertical gear shaft 320 passes, and the elastic support plate mounting portion 550, respectively.

In other words, the first plate 510 is formed therein with a first vertical gear shaft mounting hole 575 and a first elastic support plate mounting portion 555, and the second plate 520 is formed therein with a second vertical gear shaft mounting hole 576 and a second elastic support plate mounting portion 556.

A coupling hole is formed in the first plate 510 and the second plate 520.

In other words, a first coupling hole 535 may be formed in the first plate 510, and a second coupling hole 536 may be formed in the second plate 520.

For example, the first coupling hole 535 may be formed at the end of the first plate 510 from the top to the bottom of the first plate 510.

Similarly, the second coupling hole 536 may be formed in the second plate 520 at the same position.

A coupling bar may be provided in the first coupling hole 535 and the second coupling hole 536.

The coupling bar may serve to stably support the first plate 510 and the second plate 520 while maintaining the distance between the first plate 510 and the second plate 520 spaced apart from each other.

The support plate 500 is provided with a balance plate mounting portion 560.

In other words, a balance plate mounting portion 560 may be formed at the end of the second plate 520.

In addition, the balance plate mounting portions 560 may be spaced apart from each other.

A balance plate 900 may be mounted on the balance plate mounting portion 560.

According to one embodiment of the present invention, the compact apparatus for removing the scale is attached to a pipe, so that the compact apparatus for removing the scale can be rotated by a power source. The balance plate 900 serves to prevent the compact apparatus for removing the scale from being rotated by the power source.

A user may arbitrarily adjust the balance by changing the number of balance plates 900 being installed at the ends.

The support plate 500 includes an elastic support plate mounting portion 550.

In other words, the first plate 510 includes the first elastic support plate mounting portion 555, and the second plate 520 includes the second elastic support plate mounting portion 556.

Each of the elastic support plate mounting portions 550 is spaced apart from the hole in which the vertical gear shaft 320 is installed.

According to one embodiment, the elastic support plate 600 is formed in a square shape, so that the elastic support plate mounting portion 550 may be formed in a square shape.

In addition, similar to the support plate 500, the elastic support plate 600 may include a first elastic support plate 610 and a second elastic support plate 620.

In addition, the elastic support plate mounting portion 550 is longer than the elastic support plate 600.

Referring to FIGS. 5a and 5b, the elastic support plate 600 and the elastic support plate mounting unit 550 will be described.

FIGS. 5a and 5b are views showing the first elastic support plate 610 and the first elastic support plate mounting portion 555 of the first plate 510 for comparison.

It can be seen that a transverse length a of the first elastic support plate 610 is similar to a transverse length A of the first elastic support plate mounting portion 555, whereas a longitudinal length b of the first elastic support plate 610 is smaller than a longitudinal length B of the first elastic support plate mounting portion 555.

This feature can be similarly observed in the second elastic support plate 620 and the second elastic support plate mounting portion 556 of the second plate 520.

This is the same for both the first elastic support plate 610 and the second elastic support plate 620.

The elastic member 800 may be provided at a portion formed by the difference in longitudinal length between the elastic support plate mounting portion 550 and the elastic support plate 600 (difference in length between B and b that can be seen in FIGS. 5a and 5b).

In addition, the elastic member 800 may include a spring.

In other words, the elastic support plate 600 and the support plate 500 may be coupled to each other through the elastic member 800.

In other words, the elastic member 800 couples the first elastic support plate 610 and the first plate 510, and couples the second elastic support plate 620 and the second plate 520.

Therefore, the elastic member 800 correspondingly includes a first elastic member 810 and a second elastic member 820.

Accordingly, the first elastic support plate 610 and the first plate 510 may have a force flexibly changed by an elastic force of the elastic member 800, and this is also applied to the second elastic support plate 620 and the second plate 520.

Therefore, the position of the connection gear rotatably coupled to the first plate 510 and the second plate 520 through the first elastic support plate 610 and the second elastic support plate 620 is can be elastically varied.

Accordingly, the positions of the first guide wheel 330 and the second guide wheel 430 can be elastically varied.

Therefore, the force applied by the power source to the compact apparatus for removing the scale may be varied, so that the wire spring is stably guided while the compact apparatus for removing the scale is prevented from being rotated.

The connection plate 700 connects the first plate 510 and the second plate 520 spaced apart from each other

In other words, the connection plate 700 vertically connects the first plate 510 and the second plate 520.

The connection plate 700 is provided on the opposite side of the position where the first coupling hole 535 and the second coupling hole 536 are formed.

In other words, referring to FIG. 1 or 2, the connection plate 700 is disposed on the left side of the first plate 510 and the second plate 520 while vertically connecting the first plate 510 to the second plate 520.

The vertical length of the connection plate 700 is at least not less than the distance between the first plate 510 and the second plate 520 spaced apart from each other.

Accordingly, the first plate 510 and the second plate 520 are stably disposed at a distance from each other through the connection plate 700.

A bearing hole 710 is formed in an upper portion of the connection plate 700.

The second gear shaft 220 is inserted into the bearing hole 710, and the bearing hole 710 rotatably supports the second gear shaft 220.

In other words, the bearing hole 710 rotatably supports the second gear unit 200.

The elastic support plate 600 is coupled to the connection gear shaft 420.

In other words, the elastic support plate 600 rotatably supports the connection gear shaft 420, thereby rotatably supporting the connection gear unit 400.

The elastic support plate 600 includes a first elastic support plate 610 and a second elastic support plate 620.

The elastic support plate 600 is installed in the elastic support plate mounting portion 550 formed on the support plate 500.

As described above, the first elastic support plate 610 is mounted in the first elastic support plate mounting portion 555 of the first plate 510, and the second elastic support plate 620 is mounted in the second elastic support plate mounting portion 556 of the second plate 520.

In addition, the first plate 510 and the second plate 520 are spaced apart from each other by a distance, so that the first elastic support plate 610 and the second elastic support plate 620, which are mounted in the first plate 510 and the second plate 520, are also spaced apart from each other by a distance.

As described above, referring to FIGS. 5a and 5b, the lengths of the elastic support plate 600 and the elastic support plate mounting portion 550 are different from each other.

In other words, referring to the first elastic support plate 610 and the first elastic support plate mounting portion 555 shown in FIGS. 5a and 5b, the transverse length a of the first elastic support plate 610 is similar to the transverse length A of the first elastic support plate mounting portion 555, whereas the longitudinal length b of the first elastic support plate 610 is smaller than the longitudinal length B of the first elastic support plate mounting portion 555.

The elastic member 800 is provided in the space formed by the difference in longitudinal lengths B and b of the first elastic support plate mounting portion 555 and the first elastic support plate 610.

The function of the elastic member 800 is described above, so the description thereof will be omitted.

Although the present invention has been illustrated and described with respect to specific embodiments thereof, it will be apparent to those skilled in the art that various modifications and changes can be made without departing from the scope and spirit of the present invention as defined by the following claims.

What is claimed is:

1. A compact apparatus for removing scale, the compact apparatus comprising:
a wire spring mounted at an end thereof with a cutting blade and having a predetermined force to remove the scale from a pipe;
a first gear unit that rotates about a first axis;
a second gear unit that meshes with the first gear unit such that the second gear unit rotates about a second axis parallel to the first axis according to rotation of the first gear unit when the first gear unit is rotated;
a vertical gear unit having a first rotation axis perpendicular to the second axis that is a rotation axis of the second gear unit, rotatably coupled to the second gear unit, and including a first guide wheel for moving the wire spring in one direction or an opposite direction;
a connection gear unit that meshes with the vertical gear unit such that the connection gear unit is coupled to be rotatable about a second rotation axis parallel to the first rotation axis according to rotation of the vertical gear unit when the vertical gear unit is rotated, and including a second guide wheel disposed horizontally in a same plane with the first guide wheel to move the wire spring in one direction or the opposite direction together with the first guide wheel; and
a support plate for rotatably supporting the vertical gear unit and the connection gear unit,
wherein the connection gear unit includes a connection gear shaft that passes through an elastic support plate while being rotatably supported by the elastic support plate, and
the support plate has an elastic support plate mounting portion on which the elastic support plate is mounted.

2. The compact apparatus of claim 1, wherein the first gear unit includes a first gear shaft and a first gear formed along an outer periphery of the first gear shaft,
the second gear unit includes a second gear shaft, a second gear formed along an outer periphery of the second gear shaft and meshed with the first gear, and a worm formed along a longitudinal direction of the second gear shaft, and
the vertical gear unit includes a worm gear meshed with the worm.

3. The compact apparatus of claim 1, wherein the first gear unit is formed with a through-hole along a longitudinal direction to allow the wire spring to move through the first gear unit, and
the through-hole is disposed between a first guide groove formed along an outer periphery of the first guide wheel and a second guide groove formed along an outer periphery of the second guide wheel.

4. The compact apparatus of claim 2, wherein the support plate includes a first plate and a second plate spaced apart from the first plate, and
the first guide wheel and the second guide wheel are disposed in a space between the first plate and the second plate.

5. The compact apparatus of claim 4, further comprising a connection plate for connecting the first plate and the second plate spaced apart from each other.

6. The compact apparatus of claim 5, wherein the connection plate has a bearing hole for rotatably supporting the second gear shaft.

7. The compact apparatus of claim 4, wherein the vertical gear unit includes a vertical gear shaft, the worm gear, the first guide wheel, and an active gear, in which the worm gear, the first guide wheel, and the active gear are installed on the vertical gear shaft while being spaced apart from each other by a predetermined interval, and
the worm gear and the active gear are not disposed at least in the space between the first plate and the second plate.

8. The compact apparatus of claim 1, further comprising an elastic member provided between the elastic support plate and the support plate to apply an elastic force between the elastic support plate and the support plate.

9. The compact apparatus of claim 1, further comprising a balance plate provided at both ends of the support plate to maintain balance.
